(19) United States
(12) Patent Application Publication
(10) Pub. No.: US 2004/0231566 A1
(43) Pub. Date: Nov. 25, 2004

(54) Process for Fly Ash Beneficiation

(75) Inventors: Hugh H. Wang, Valrico, FL (US); Stephen M. Bryan, Kingwood, TX (US)

Correspondence Address: HOWREY SIMON ARNOLD & WHITE LLP, 750 BERING DRIVE, HOUSTON, TX, 77057, US

(73) Assignee: CEMEX INC., Houston, TX (US)

(21) Appl. No.: 10/249,935

(22) Filed: May 20, 2003

(51) Int. Cl. C04B 14/00; C04B 18/06

(52) U.S. Cl. 106/705

(57) ABSTRACT

A process is disclosed for converting low reactive fly ash to a highly reactive pozzolanic material by heating the fly ash until at least a portion of the fly ash melts; then rapidly cooling the fly ash. The resulting vitrified fly ash has improved cementitious properties relative to untreated fly ash.

### BACKGROUND OF INVENTION

Coals are used in power plants throughout the world to produce electricity. One by-product of coal combustion is an inorganic residue known in the building materials industry as “fly ash.” Fly ashes accumulate rapidly and can cause enormous waste disposal problems unless an effective use is found for these by-products. The building materials industry is a leader in utilizing the fly ash in cement and concrete. Using coal fly ash has great benefit to society for resource conservation and environmental protection. For example, using fly ash in place of cement conserves energy by reducing the demand for cement, which takes energy to produce. Each ton of fly ash that replaces a ton of cement not only saves the equivalent of about one barrel of oil, this substitution also reduces the production of greenhouse gases that would otherwise contribute to global warming.

Fly ash is termed a “pozzolan” in the cement and concrete industry. A pozzolan is defined as a finely divided material that reacts with calcium hydroxide and alkalis to form compounds possessing cementitious properties. Only the glassy (amorphous) phase of the fly ash is the active pozzolanic portion. Typical fly ash contains about 50-80% glassy phase. The remainder of the fly ash is composed of mineral phases, including the aluminum silicates mullite (3A1₂O₃Â.2SiO₂) and sillimanite (Al₂O₃Â.SiO₂); quartz (SiO₂); and iron oxides such as magnetite (Fe₃O₄), and hematite (Fe₂O₃). Other constituents that may be present in high-calcium fly ash include periclase (MgO), anhydrite (CaSO₄), lime (CaO/Ca (OH)₂), alkali metal sulfates (for example sodium sulfate and potassium sulfate), melilite, merwinite, dicalcium silicate (2CaOÂ.SiO₂ or “C₂S”), and tricalcium aluminate (3CaOÂ.Al₂ O₃ or “C₃A”). The successful cement performance of the fly ash depends significantly on the percentage of the glassy portion of the phases in the fly ash. A larger fraction of glassy phase results in better and more consistent performance. Several fly ash beneficiation technologies have been proposed and used commercially. Some of these are described in the following paragraphs.

Ammonia Removal: ReUse Technology of Kennesaw, Ga. has described a process for removing ammonia from fly ash. Available NOₓ reduction technologies may contaminate the fly ash with various ammonia compounds or leave unburned carbon in ash. Carbon Separation from Fly Ash: Separation Technologies, Inc (STI) of Needham, Massachusetts have described an electrostatic dry separation system for separating unburned carbon from ash. Particles are triboelectrically charged by inter-particle contact. Carbon particles retain an opposite charge to the fly ash particles. Feed ash at 4.530% LOI is beneficiated to 2% LOI.

Carbon Burnout from Fly Ash: Progress Materials Inc. has patented a process to remove carbon by burning the fly ash to about 1300-1800Â° F. (700-980° C.). The process is purely a removal of unburned carbon in the fly ash--no modification of mineral phases or crystal structure is involved. The fly ash from Carbon Burnout Technology still has 2% LOI.

Particle-Size Reduction: U.S. Pat. Nos. 4,054,463; 4,171,951; and 4,482,096 by Lin describe a process for heating fly ash to about 300800Â° C. and then quenching it, which causes sulfate phases to evaporate and the particles to crack, thereby reducing the particle size and increasing the surface area-to-volume ratio. The patents suggest that the increased surface area results in improved cement performance. No conversion from crystal to glassy phase takes place at the temperatures used in these patents.

In addition to the above, a 1999 paper by Cedzynska et al. describes a method of treating toxic wastes from industrial, medical and military applications by mixing the waste with about 50% fly ash and plasma-vitrifying the mixture of fly ash and waste material at extremely high temperatures (on the order of 10,000 K). This purpose of this process is to solidify the waste material so that it may be safely disposed of in landfills or used as aggregate in the construction industry.

There are many other technologies proposed for fly ash beneficiation, such as carbon removal by wet separation. Although many of the aforementioned beneficiation techniques are commercially used to remove the undesirable components and thus to improve the performance of the fly ash, none of these is capable of converting all of the mineral phases into a single glassy phase. Accordingly, a need still exists for a process that can achieve this phase conversion to provide superior cementitious performance. The present invention satisfies this need.

### SUMMARY OF INVENTION

According to the present invention, a process is disclosed for converting crystal phases in the fly ash to the glassy or amorphous phase by heating the fly ash to its melting point, then rapidly cooling the heated fly ash to preserve the high temperature glassy phase, thereby producing a highly reactive pozzolanic material. In a preferred embodiment, the fly ash is heated to at least about 1150Â° C. In certain preferred embodiments the heating step is carried out in a kiln, furnace, or fluidized bed, but other heating apparatus are also suitable.

### BRIEF DESCRIPTION OF DRAWINGS

Other objects and advantages of the invention will become apparent upon reading the following detailed description and upon reference to the drawings in which:

FIG. 1 is a composition diagram depicting the relative amounts of calcium oxide, silica and alumina in a number of cementitious and pozzolanic materials.

FIG. 2 is a graphical representation of the relationship between phase structure (crystalline or glassy) and reactivity with alkaline, which is a qualitative measurement of a pozzolanic material's performance.

FIG. 3 depicts the difference in X-ray diffraction (XRD) patterns observed for crystalline and glassy materials. It will be noted that crystalline materials are characterized by sharp, narrow peaks in the XRD pattern.

FIG. 4 depicts XRD spectra for a number of materials including vitrified and untreated fly ash and ground granulated blast furnace slag.

FIGS. 5 and 6 are a comparison of cement hydration performance for cements including a variety of pozzolanic additives including treated and untreated fly ash and granulated blast furnace slag.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is intended to cover all modifications, equivalents and alternatives falling within the scope of the invention as defined by the appended claims.

### DETAILED DESCRIPTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers” specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

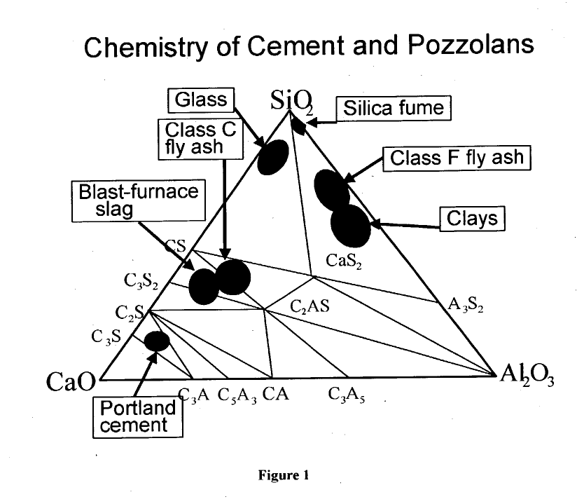

Referring now to FIG. 1, the compositions of a number of cementitious and pozzolanic materials are shown. It has long been known that granulated blast furnace slag is a useful pozzolan for cement and concrete applications, both used alone and as a component in concrete mixtures. For example, blast furnace slag has been used for decades as an inexpensive additive to portland cement concrete. As FIG. 1 indicates, the chemical composition of Class C fly ash is quite similar to that of granulated blast furnace slag. However, untreated commercial fly ash contains a significant fraction of crystalline material that is not reactive. By way of contrast, blast furnace slag is composed nearly entirely of amorphous material.

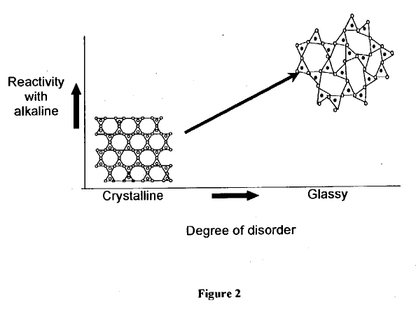

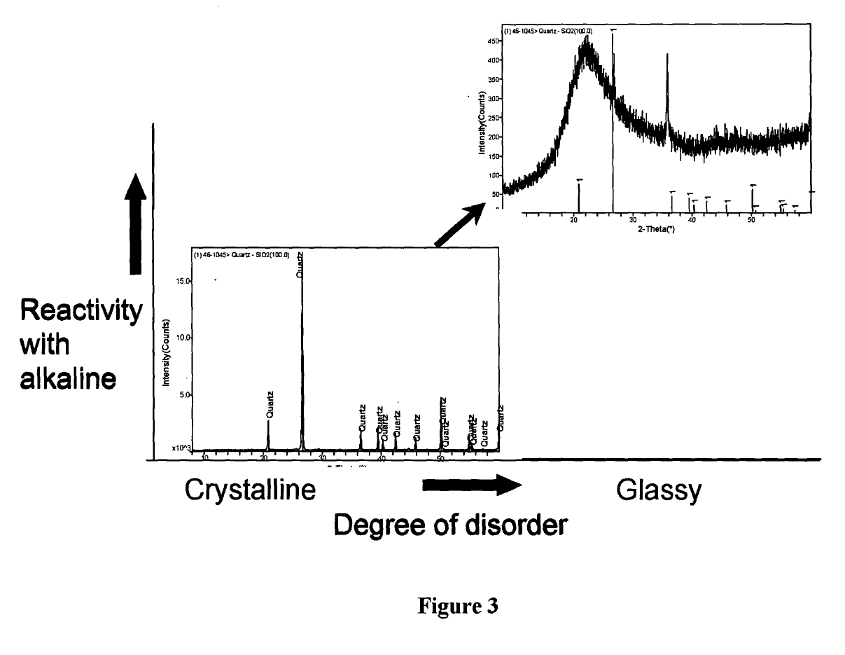

FIG. 2 is a representation of the increased reactivity with alkaline that results as the fraction of amorphous phase in the material increases. The crystalline and amorphous materials are represented by idealized depictions of their respective structures, which show the difference between the materials in terms of their degree of disorder. FIG. 3 depicts the same relationship between reactivity and degree of disorder as shown in FIG. 2, but in FIG. 3 the crystalline and amorphous materials are represented by X-ray diffraction (XRD) patterns, which differ significantly depending on the degree of crystallinity in a material. As the figure shows, materials with large fractions of crystallinity have XRD patterns with sharp, intensive peaks, while glassy or amorphous materials are characterized by broad XRD patterns with no sharp peaks.

The present inventors have devised a process for converting most (or all) of the mineral phases in fly ash into the glassy phase. The process involves heating the fly ash to (or nearly to) the melting point to convert the mineral phases to a single glassy phase, and then quenching the melted fly ash to preserve this glassy phase. This process is defined as fly ash phase conversion or vitrification. As used in this disclosure, the term “vitrify” means to convert a material from one or more crystalline phases to a single glassy phase. Also as used in this disclosure, “fly ash” should be understood to refer not only to coal fly ash but to include any ash generated as a power generation by-product, including but not limited to bottom ash, and other waste ash or waste material that is composed mostly of silica, alumina and calcium oxide. It should also be understood that “fly ash” includes such waste materials whether freshly generated or after any period of nondestructive storage such as landfilling.

The fly ash may be subjected to heat treatment in any apparatus that can heat the fly ash to a temperature at or near its melting point and provide a mechanism to rapidly quench the melted fly ash, preserving the high temperature glassy phase. The apparatus is not limited to traditional rotary or shaft kilns but can be a fluidized bed, tunnel furnace, a microwave oven, or the like, though kilns and fluidized beds are preferred.

The applicants have found that a minimum temperature of about 1150Â° C. is required to vitrify a typical fly ash. At or above this temperature, all of the mineral phases in the fly ash can be converted to the amorphous phase. It appears that temperatures above about 1350Â° C. do not provide any significant additional benefit. The quench temperature can be any temperature sufficiently low to prevent any reversal of the phase transition. Ambient temperatures, for example about 20Â° C., are preferred. The quenching step may be carried out, for example, by contacting the vitrified fly ash with a stream of air or water.

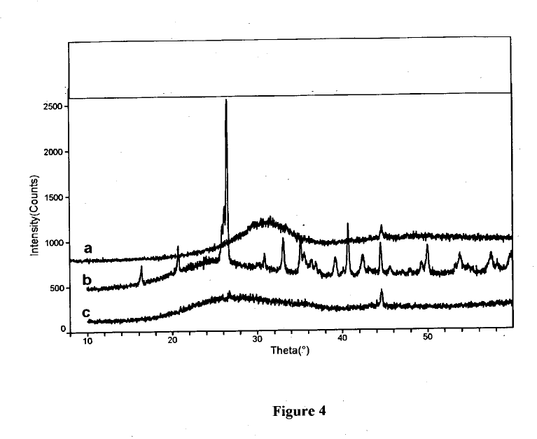

FIG. 4 depicts the effects of the present process. The upper XRD spectrum 1 in the figure is that of a sample of ground granulated blast furnace slag, which is substantially all amorphous as stated above, and is provided for comparison. The middle XRD spectrum 2 in FIG. 4 is that of an untreated fly ash sample. It will be apparent from the numerous sharp peaks in the XRD pattern and the discussion hereinabove that this sample contains a significant quantity of crystalline material. The lower spectrum 3 in FIG. 4 represents the same material after treatment by the present process. In comparison to the untreated sample, it will be clear that the process has eliminated the crystalline material, leaving only the amorphous phase.

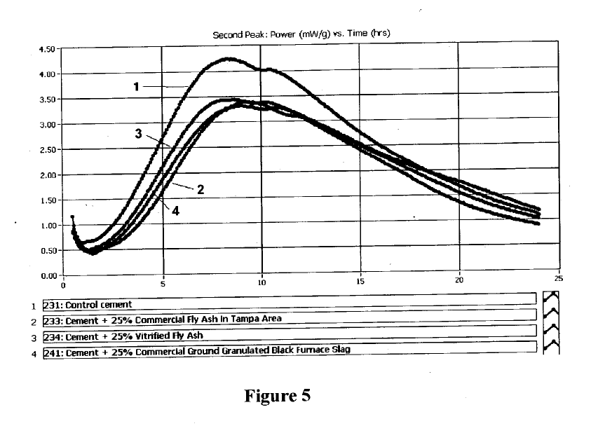

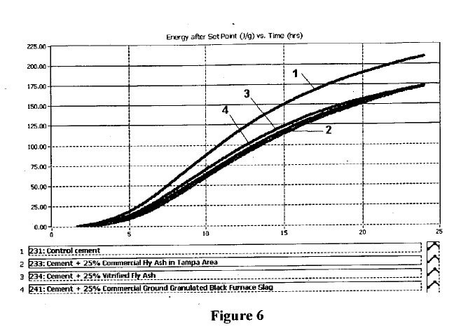

FIGS. 5 and 6 depict the hydration performance over time of a number of cement samples prepared by adding 25% pozzolanic material to portland cement. A number of pozzolans were used, including granulated ground blast furnace slag; a commercial fly ash from the Tampa, Florida area; and vitrified fly ash according to the present invention (87.5% passing 44 microns). The heat evolution rate (mW/g) over time is shown in FIG. 5; the total heat of hydration (J/g) over time is shown in FIG. 6. The onset of heat evolution rate (FIG. 5) is an indication of the cement setting characteristics after mixing with water. Ideally, addition of a pozzolan would not change the onset of heat evolution; but most of the pozzolans, especially fly ash, always delay the onset of the heat evolution. The longer the delay on the onset time, the longer the cement and concrete set. The amount of total heat released (FIG. 6) is an indication of cement and pozzolan hydration rate. Most pozzolans, especially fly ashes, significantly reduce the total heat release, particularly in the early age. This decreases the early age strength development. FIG. 5 shows that the effect of the vitrified fly ash on the onset of cement hydration heat release is the least, while untreated fly ash significantly delayed the onset of the cement hydration heat release. FIG. 6 shows that although the total heat release at 24 hours for all three pozzolans is about the same, the vitrified fly ash releases more heat before 24 hours. This is an indication of higher strength development in the time frame of several hours.

The process described herein provides a number of benefits. The conversion of the crystalline mineral phases to a single glassy phase increases the active pozzolanic portion of fly ash and improves the predictability of fly ash performance. Additional benefits of the process include (1) reducing the potential of the fly ash-cement-chemical admixture incompatibility in the concrete application; (2) reducing the possibility of fly ash-induced slow setting or slow early age strength development, and (3) eliminating or reducing the negative effect by the organic matter and highly volatile components present in the fly ash. It will be apparent to those of skill in the art that the processes described herein will also be effective to increase the fraction of glassy phase, or to achieve one or more of the additional benefits described hereinabove, in other pozzolanic materials such as waste slag.

While the invention has been described with reference to the preferred embodiments, obvious modifications and alterations are possible by those skilled in the related art. Therefore, it is intended that the invention include all such modifications and alterations to the full extent that they come within the scope of the following claims or the equivalents thereof.

1. A process for producing a blended cement, comprising the steps of:
heating fly ash until at least its melting point;
rapidly cooling the heated fly ash to produce vitrified fly ash; and
mixing the vitrified fly ash with a calcareous material to form a cement,
wherein at least one performance characteristic of said cement is improved relative to a blend of said calcareous material with unprocessed fly ash.

2. The process according to claim 1, wherein in the heating step the fly ash reaches a temperature of at least about 1150° C.

3. The process according to claim 2, wherein in the heating step the temperature of the fly ash does not exceed about 1350° C.

4. The process according to claim 2, wherein in the cooling step the fly ash is cooled to ambient temperature.

5. The process according to claim 1, wherein the rapid cooling is accomplished by quenching the heated fly ash with air or water.

6. The process according to claim 1, wherein the heating step is carried out in a vessel selected from the group consisting of rotary kilns, shaft kilns, furnaces, fluidized beds, and microwave ovens.

7. The process according to claim 6, wherein the heating step is carried out in a kiln.

8. The process according to claim 6, wherein the heating step is carried out in a fluidized bed.

9. The process according to claim 1, wherein the fly ash comprises at least one mineral phase and an amorphous phase, and the heating step converts at least a portion of the mineral phase to the amorphous phase.

10. The process according to claim 9, wherein the amorphous phase comprises about 50 percent to about 90 percent of the unprocessed fly ash.

11. The process according to claim 9, wherein at least a majority of the mineral phase is converted to the amorphous phase.

12. The process according to claim 11, wherein substantially all of the mineral phase is converted to the amorphous phase.

13. The process according to claim 1, wherein the vitrified fly ash has improved cementitious properties relative to unprocessed fly ash.

14. The process according to claim 13, wherein the vitrified fly ash has a loss on ignition of less than about 2% by weight.

15. (Cancelled)

16. The process according to claim 1, wherein the calcareous material is selected from the group consisting of calcium hydroxide, calcium oxide, gypsum, calcium silicates, calcium aluminates, and mixtures thereof.

17. A blended cement comprising a processed fly ash and at least one calcareous material other than the processed fly ash, said processed fly ash comprising an amorphous phase, wherein the amorphous phase comprises at least about 95 weight percent of the processed fly ash.

18. (Cancelled)

19. The blended cement according to claim 17, wherein the calcareous material is selected from the group consisting of calcium hydroxide, calcium oxide, gypsum, calcium silicates, calcium aluminates, and mixtures thereof.

20. The blended cement according to claim 17, wherein said blended cement comprises Portland cement.

21. The process according to claim 1, wherein said calcareous material comprises Portland cement.

22. The process according to claim 1, wherein said performance characteristic is selected from the group consisting of early age strength development, hydration rate, and compatibility between said ash and said calcareous material.
